(19) United States
(12) Patent Application Publication
(10) Pub. No.: US 2009/0310944 A1
(43) Pub. Date: Dec. 17, 2009

(54) Method and Apparatus for Maximizing "Last Mile" Bandwidth Through Non-Real-Time Personal Video Recorder (PVR) Transmission in Internet Protocol Television (IPTV) Systems

(76) Inventor: Andrew V. Kispert, JR., Kirkland, WA (US)

Correspondence Address: MICHAEL N. HAYNES, 1341 HUNTERSFIELD CLOSE, KESWICK, VA, 22947, US

(21) Appl. No.: 12/300,679

(22) PCT Filed: Sep. 15, 2006
(86) PCT No.: PCT/US06/36080

§ 371 Date: Dec. 29, 2008

Related U.S. Application Data
(60) Provisional application No. 60/801,643, filed on May 19, 2006.

(51) Int. Cl. H04N 7/26

(52) U.S. Cl. 386/124

(57) ABSTRACT

A system includes a head-end encoder configured to stream a television program to an intermediate server (104) operably coupled to the head end encoder at a first bit rate; and a user device (106) operably coupled to the intermediate server (104); wherein the intermediate server (104) is configured to selectively stream the television program to the user device (106) at less than the first bit rate.

### CROSS REFERENCE TO RELATED APPLICATIONS

This application claims priority from U.S. Provisional Application Ser. No. 60/801,643, filed May 19, 2006.

### BACKGROUND OF THE INVENTION

1. Field of the Invention

This invention relates to Internet Protocol television (IPTV) systems. More particularly, the invention relates to systems and methods for recording programs using a personal video recorder (PVR) in an IPTV system.

2. Description of the Related Art

Most IPTV systems today that offer personal video recorder (PVR) functions stream content in real-time for either recording or viewing directly from a head-end encoder to subscribers' set-top boxes. The types of PVR offered today are usually client-side PVR (cPVR) or network-based PVR (nPVR) where each type of PVR service receives content streamed in real-time for recording. The main difference is where the content is stored.

In nPVR systems, the multimedia content is streamed in real-time from an nPVR server in order to be viewed by a subscriber. One advantage cPVR has over nPVR is that the content does not have to be streamed over a network connection in order to be watched at a later time, thus alleviating the impact on network connections. One disadvantage of cPVR over nPVR is that recording of content being streamed in real-time (at a rate necessary for viewing) has an impact on the available bandwidth being used for other applications. That is, the same amount of bandwidth is required for recording as viewing.

### SUMMARY OF THE INVENTION

A system according to embodiments of the present invention provides a PVR apparatus that enables recording of multi-media content (for viewing at a later time) in non-real-time, thus alleviating the impact on ‘last mile’ bandwidth and permitting the simultaneous recording of multiple multi-media streams.

Embodiments of the present invention thus allow the amount of bandwidth utilized for recording a multi-media stream to be dynamically selected ahead of time based on subscriber preferences. For example, a subscriber may choose to record a sporting event that occurs in the middle of his work day and plan to watch it in the evening. In this scenario, the subscriber may have the sporting event streamed for recording at a rate taking longer (e.g., up to several hours longer) than the duration of the actual event utilizing less ‘last mile’ bandwidth for the purposes of transporting the multi-media content.

A method according to an embodiment of the present invention includes selecting a television program to record at a user device; receiving a bit stream corresponding to the television program at a first bit rate at a server; and receiving a bit stream corresponding to the television program at the user device from the server at a second bit rate less than the first bit rate.

A system, according to an embodiment of the present invention, includes a head-end encoder configured to stream a television program to an intermediate server operably coupled to the head end encoder at a first bit rate; and a user device operably coupled to the intermediate server; wherein the intermediate server is configured to selectively stream the television program to the user device at less than the first bit rate.

A program product stored on one or more computer readable devices according to an embodiment of the present invention includes code executable to cause selecting a television program to record at a user device; code executable to cause receiving a bit stream corresponding to the television program at a first bit rate at a server; and code executable to cause receiving a bit stream corresponding to the television program at the user device from the server at a second bit rate less than the first bit rate.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 illustrates an exemplary system according to an embodiment of the present invention.

FIG. 2 illustrates an exemplary user interface for use with a system in accordance with embodiments of the present invention.

FIG. 3 is a flowchart illustrating operation of an embodiment of the present invention.

FIG. 4 is a signaling diagram illustrating operation of an embodiment of the present invention.

FIG. 5 is a diagram illustrating operation of an embodiment of the present invention.

FIG. 6A-FIG. 6B illustrate an exemplary media distribution system that may be used in with a personal video recorder system according to embodiments of the present invention.

FIG. 7A-FIG. 7B is a diagrammatic representation of a user station and system that may be used to implement methods according to embodiments of the present invention.

### DETAILED DESCRIPTION OF EMBODIMENTS OF THE INVENTION

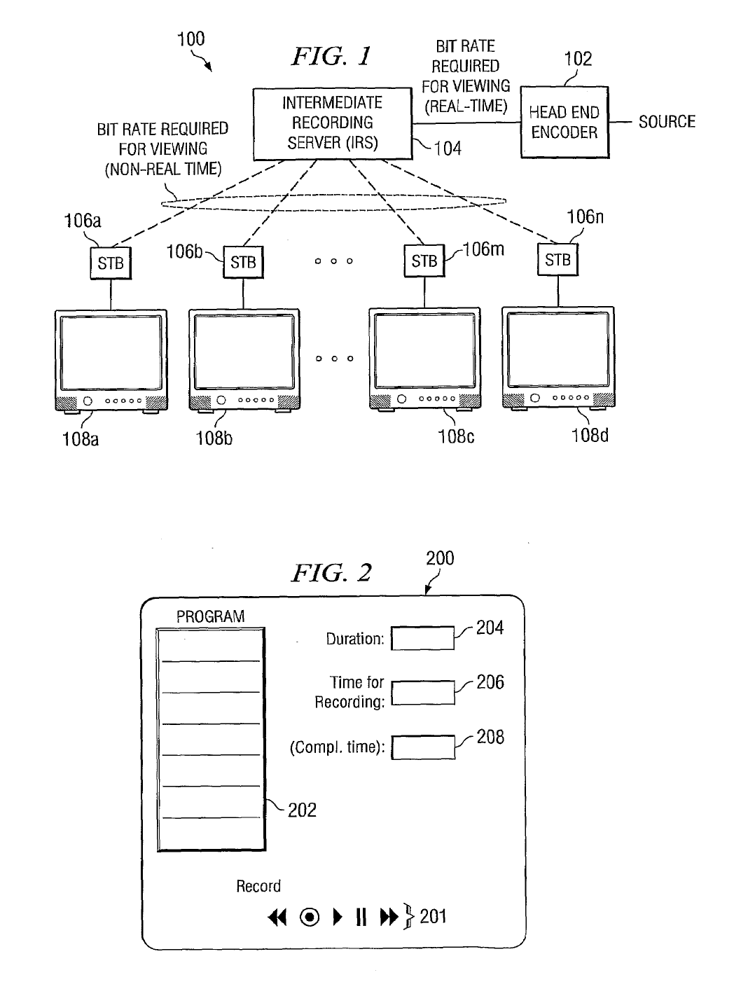

Turning now to the drawings and, with particular attention to FIG. 1, a diagram of a media delivery and personal video recorder (PVR) system in accordance with embodiments of the present invention and generally identified with the reference numeral 100.

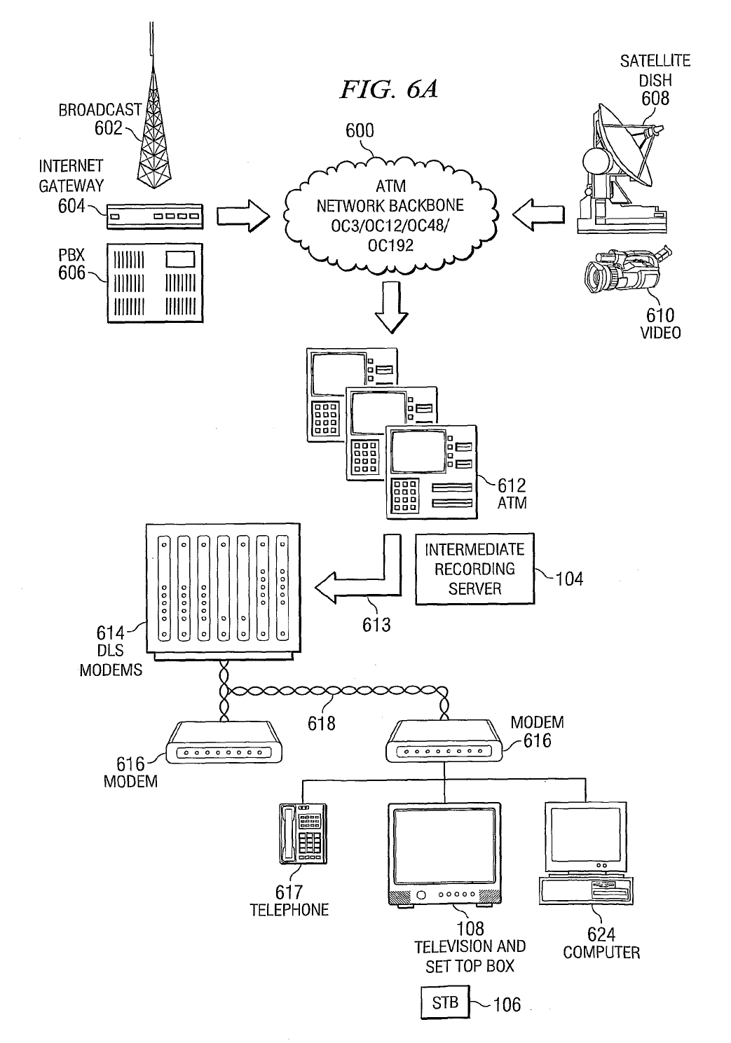

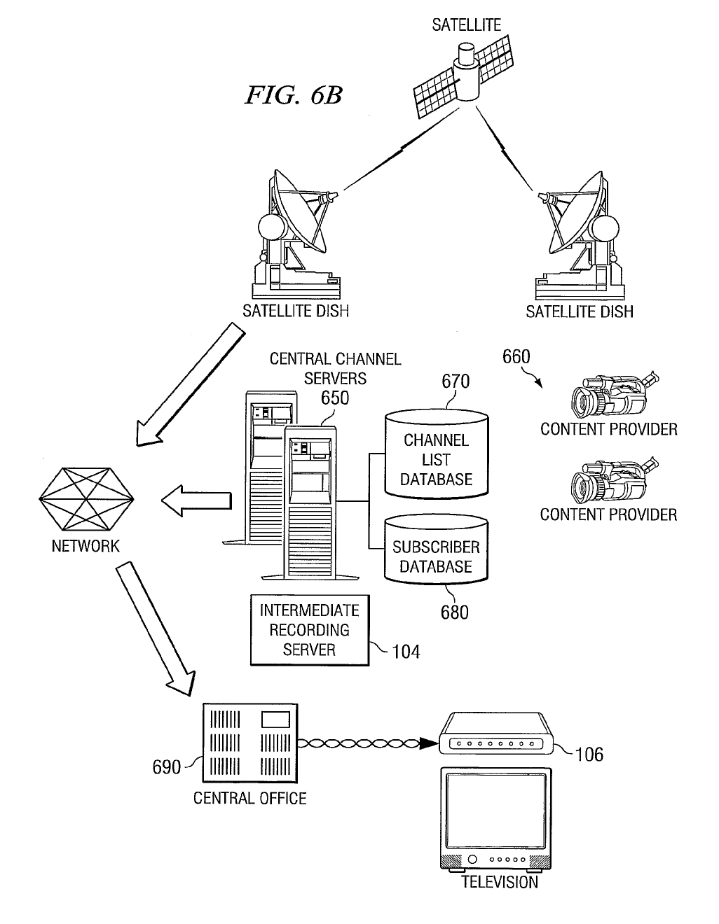

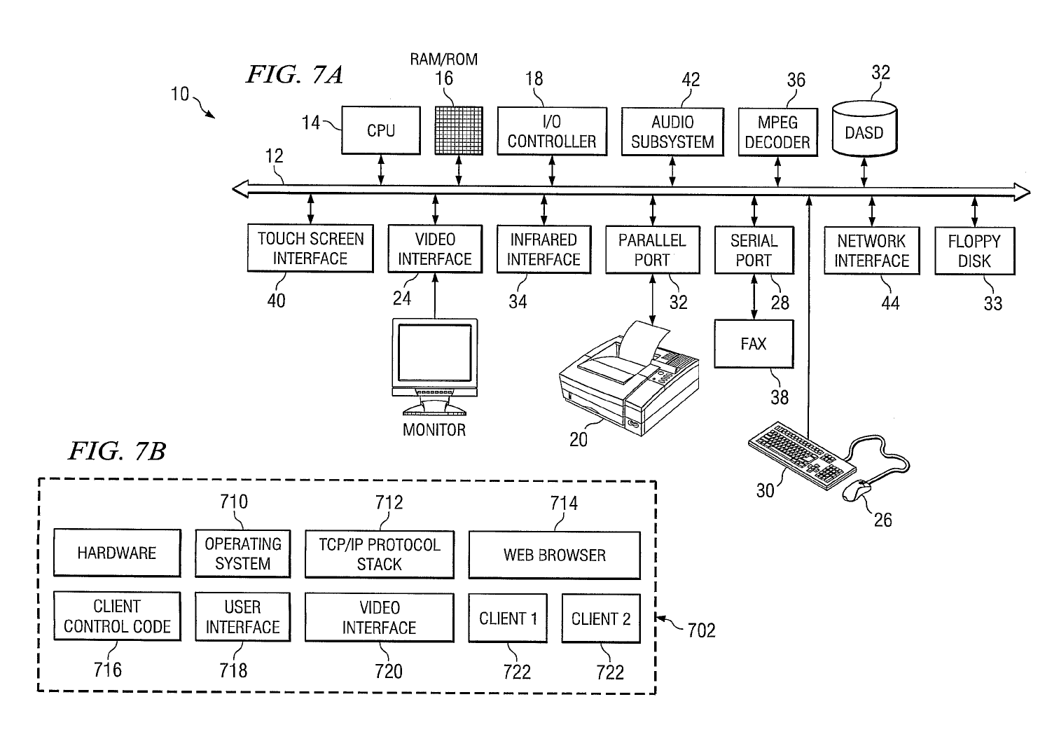

The system 100 includes a head end encoder 102, which may receive, e.g., television content and encode it for delivery on, e.g., a packet switched Internet Protocol (IP) network. The head end encoder 102 may be embodied in or part of a content server (not shown) that can provide content to one or more user devices. Such content can include, for example, video broadcasts such as single-channel or multi-channel television programming, single-channel or multi-channel audio broadcasts, audio-on-demand, video-on-demand, Internet-based content, voice over IP, etc. A media distribution system that may be used in association with a personal video recorder system in accordance with embodiments of the present invention will be described in greater detail below with reference to FIG. 6A-6B and FIG. 7A-7B.

The user devices may be embodied as one or more set top boxes (STB) 106a-106n. The STB's 106a-106n may be coupled to or in communication with one or more televisions 108a-108n for viewing or receiving the content. Thus, the STBs 106a-106n may each include a user interface component (not shown) that can provide or modify content being provided to the television associated with the STB (e.g., to display a menu of services or to select one or multiple channels from content provided by a third party). The STBs 106a-106n may further include personal video recorder functionality and memory for storing and playing back program content, as will be explained in greater detail below. In addition, in some embodiments, the STBs 106a-106n are connected to or in communication with one or more switched telephone network central offices (not shown) via, e.g., one or more DSL (digital subscriber line) lines. In such embodiments, packet-switched IP data routing is used to provide information about viewer interactions (e.g., content selection and other content viewing interactions), such as for viewers that are subscribers of a service providing various types of content and content-related services. In some embodiments, the media streams provided to and from the IRS 104 are implemented using the MPEG-2 standard.

Also shown in FIG. 1 is an intermediate recording server (IRS) 104. As will be explained in greater detail below, the IRS 104 includes memory for recording programming, and is able to stream content to the STBs 106a-106n at variable bit rates. The IRS 104 receives requests to record programming from the STBs 106a-106n. The requests include program identification, as well as an identification of a time period over which the recording should take place. The programming is then transmitted at the scheduled time by the head end encoder 102 to the IRS 104. The IRS 104 stores the program in memory (not shown). The program is then streamed to the requesting STB 106a-106n for storage at the less-than real-time rate and time period specified. Thus, as will be explained in greater detail below, the programming from the head end encoder 102 to the IRS 104 may be streamed in real time. The transmission to the STB 106a-106n will be done at less than real time. Embodiments of the present invention thus allow a user to increase the number of programs he can record at a given time, thereby maximizing “last mile” bandwidth.

As noted above, the STBs 106a-106n may each include a user interface, for interacting with a service provider. An exemplary graphical user interface 200 that a viewer may employ to interact with personal video recording services according to embodiments of the present invention is shown in FIG. 2. The user interface includes one or more standard video recorder type tools 201, such as PLAY, RECORD, PAUSE, FAST FORWARD or REVERSE, etc. In addition, the GUI 200 includes a program listing 202, and may include a duration entry 204, a time for recording entry 206, and a completion time 208.

In operation, the viewer can use a pointing device such as an infrared remote in conjunction with the GUI 200 to select a program for recording (e.g., while viewing another program or at a future date) and can set a period or duration that the recording should take place (e.g., a specific number of minutes or hours or a multiple of a real-time duration). According to some embodiments, the user could also set a time the recording to the STB 106 is to occur, or a “no later than” completion time the recording to the STB should be finished. In addition, in some embodiments, the end user may be able to make adjustments to the IRS 104 to STB 106 download time once set or even while downloading is occurring. That is, once a transmission is set up, some embodiments allow users to further adjustment bandwidth based on a change to the required time period to complete the transmission.

For example, suppose a user wanted to record a tennis match that occurs during the day, say from 10 AM to 11 AM, while he is at work. He expects to return home no earlier than 6 PM and wants to watch the match at 8 PM. He can use the program guide to select the time and channel at which the program is scheduled.

In some embodiments, he can select the number of hours over which the recording could occur. Since he doesn't expect to watch the program until 8 PM, he could choose a maximum of 10 hours. When the program airs, the IRS 104 will begin to receive and record the real-time stream from the head end encoder 102 at 10 AM; the IRS 104 can then stream the program to the STB 106 at less than real-time, such that the recording is completed no later than at the time corresponding to the number of hours selected.

In other embodiments, the user can simply select the completion time. In this example, the completion time would be 8 PM. The IRS 104 would select a bit rate such that the recording to the STB 106 is finished no later than the completion time.

In other embodiments, the user could adjust the download by changing the maximum duration or end time. For example, if he arrives home at 4:30 and wants to watch sooner, he could adjust the end time to, say, 7 PM. The download can then be “speeded up.” Alternatively, he could adjust it to a later time, thereby “slowing down” the download.

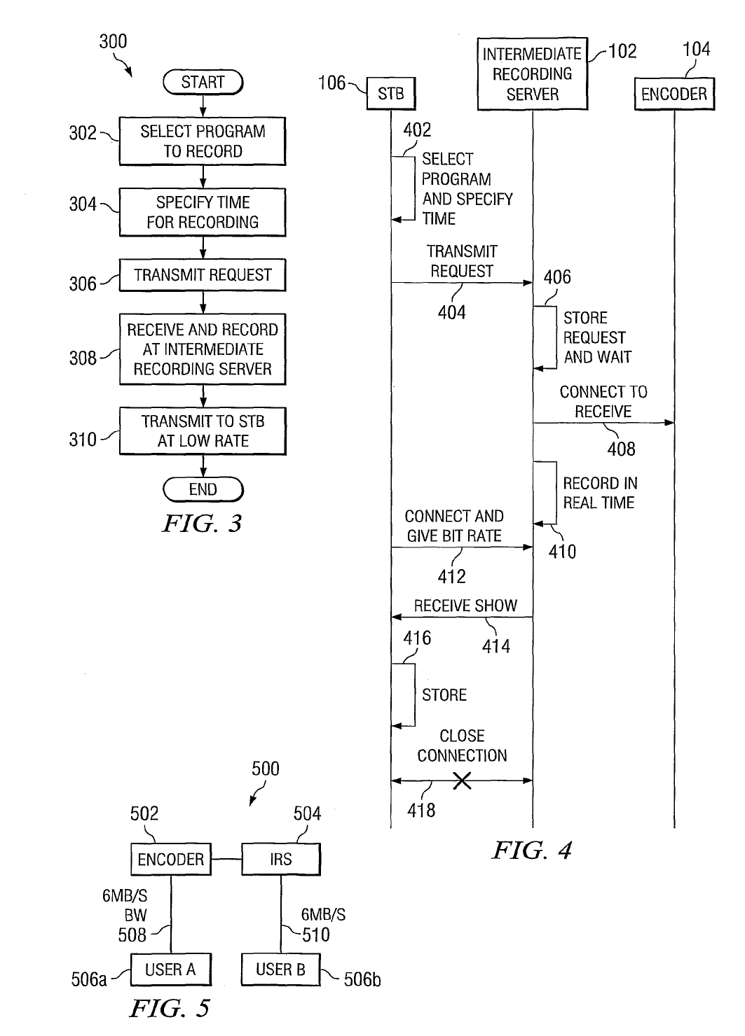

Turning now to FIG. 3, a flowchart 300 illustrating operation of embodiment of the present invention is shown. The particular arrangement of elements in the flowchart 300 is not meant to imply a fixed order to the elements; embodiments can be practiced in any order that is practicable.

Initially, in a process step 302, a viewer can select a program to record, for example, using a user interface similar to that shown in FIG. 2. As discussed above, this can include selecting a program from a program listing, which automatically includes date, time, and channel information. In some embodiments, it can include manually entering a date, program channel, and start and end times.

In a process step 304, the viewer can specify either a time over which the recording should occur, or a completion time for recording the program. In a step 306, the viewer can transmit the request to the IRS 104. In a step 308, the IRS 104 receives and holds the request until the scheduled time; and records the program at the scheduled time. In a process step 310, the IRS 104 transmits the program to the requesting STB 106, either over the period selected, or no later than the selected completion time. Again, in some embodiments, the user can adjust an already-set duration or download time.

Operation of an embodiment of the present invention is shown in greater detail in FIG. 4. Shown are an exemplary STB 106, an IRS 102, and a head end encoder (ENC) 104.

At 402, a viewer can use his user interface to specify a program to be recorded and a time of the recording (or a completion time). At 404, the STB 106 transmits the request to the IRS 102. At 406, the IRS 102 stores the request and waits until the time the program is aired, if necessary. At 408, the IRS 102 connects to the ENC 104 to receive the program. At 410, the IRS 102 records the program in real time. At 412, the STB 106 connects to the IRS 102 to receive the program. In 414, the program is transmitted at the specified timing to the STB 102. At 416, the STB 102 stores the program in its content store (not shown). Finally, at 418, the connection is closed when the program has been stored.

Advantages of embodiments of the present invention are seen by way of example in FIG. 5. Shown at 500 are en encoder ENC 502, an IRS 504, a User A 506a which receives content directly from the ENC 502 and a User B 506b that receives content via the IRS 504. The typical bit rate required to render standard definition television (SDTV) is approximately 3 Mb/s (3 megabits per second). If User A 506a has a bandwidth of 6 Mb/s directly to the ENC 502, then he can only record one program while watching another, or record only two at a time. User B, however, could choose to record, for example, a one hour show in standard definition over a six hour period. This would require transmitting from the IRS 102 at total of 10,800 Mb. Over six hours, this corresponds to a rate of 0.5 Mb/s. Thus, subscriber B 506b could concurrently record twelve programs, or six times the number that subscriber A 506a could.

Embodiments of the present invention thus maximize “last mile” bandwidth for IPTV systems for recording content on an STB for viewing at a later time. Bandwidth usage at the user end is limited to provide a greater number of concurrent recordings.

As discussed above, embodiments of the present invention are suited to an internet protocol media distribution system. FIG. 6A depicts a representative environment according to the invention. Central to FIG. 6A is a network with ATM network backbone 600. This ATM network is capable of fiber data rates of OC3, OC12, OC48, OC192 or as is available in the art. A plurality of content providers place information onto ATM network 600. Typical sources of content served include broadcast information 602, Internet information 604, telenetwork 606, broadcast content 608, and video 610.

In a representative central plant, a plurality of ATM switches 612 interface with network 600 to receive and distribute data from the various content sources. An IRS 104 in accordance with embodiments of the present invention may be located upnetwork from the end user. Information flows from ATM switches 612 via a plurality of paths 613 to a plurality of DSL modems 614. DSL modems 614 connect via DSL twisted pair lines 618 to a plurality of modems 616 in various subscribers residences or establishments. From a representative modem 616, there can be attached a telephone 617 and/or a television set 108 which may include and associated set top box 106, and/or a computer 624. The PVR of embodiments of the present invention may thus be operable on or in association with devices such as telephone 620, television with set top box 106, and/or computer 624.

FIG. 6B depicts an overview of a digital programming content distribution system according to a particular embodiment of the present invention. One or more central channel server(s) 680, which may implement the head end encoder(s) described herein, collect(s) information about available programming services distributed from a multiplicity of content providers 660. In a preferable embodiment, this information is multicast by the content providers. Channel server 680 maintains a channel list database 670 which tracks available content channel offerings and a subscriber database 680, which contains subscriber identifications and permitted channels for each subscriber. Subscribers interact with central channel server 680 to obtain programming content information, and with content providers 660 to obtain programs. The IRS 104 may be implemented as part of or in conjunction with the central channel servers 650. Alternatively, the IRS 104 may be implemented in conjunction with the central office 690. In related embodiments, the channel server 680 and content providers 660 may be co-located on the same machine, or may reside on separate machines.

In a representative embodiment, the invention may be practiced using a control system with the basic subsystems and functions depicted in FIG. 7A. In particular, the control unit of FIG. 7A represents, for example, a set top box 106 or an intermediate recording server 104.

In the representative system of FIG. 7A, a control unit 10 includes bus 12, which is shown schematically as a single bus, but can also be a number of buses such as a local bus and one or more expansion buses (e.g., ADB, SCSI, ISA, EISA, MCA, NuBus, or PCI), which interconnect subsystems such as a central processor 14, which may be an 80×89, 98xxx, RISC, Pentium family, or other suitable microprocessor family, system memory 19, which may be RAM, ROM, or a combination thereof, input/output (I/O) controller 18, an external device such as a serial port 28, such as a USB port, and parallel port 32, detachable keyboard 30, mouse 29, fixed disk drive 32, which may be a hard disk drive or an optical drive or a CD-ROM or DVD-ROM drive or other suitable medium; and a floppy disk drive 33 operative to receive a floppy disk.

Network connections are usually established through one or more network adapters 44 attached to one of the buses or a modem on a serial port. Network adapters may include 10 Base T, 100 Base T, optical, ATM, DSL, or other network formats.

MPEG decoder 39 and audio subsystem 42 coupled via bus 12 provide multimedia capability. Many other devices can be connected such as fax 38 connected via serial port 28, touch screen 40 connected directly, infrared peripheral support 34 or printer 20, connected through parallel port 22. Other devices or subsystems (not shown) may be connected in a similar manner. Also, it is not necessary for all of the devices shown in FIG. 7A to be present to practice the invention. The devices and subsystems may be interconnected in different ways from that shown in FIG. 7A without impairing the operation of the system. Source code to implement processing functions in accordance with the present invention may be operably disposed in system memory 16 or stored on storage media such as fixed disk 32 or floppy disk 33.

Video interface 33 may be any standard video format, such as S-video. Various forms of user input devices may be used with the set top box and/or IRS. For example, a touch screen allows a user to point to objects on the screen to select the object and to move the selected object by pointing to a second position on the screen. Alternatively, an infrared or other coupled handheld control unit may be interfaced with the STB or IRS allowing the user to interact with the unit, make changes, and indicate preferences. Various buttons and controls may be displayed on the screen for activation by using the mouse, touch screen, or a remote control via infrared IF 34.

Operatively disposed in memory 19, or resident on fixed disk 32, operating system software may be PSOS, DOS, UNIX, WINDOWS95, WINDOWS CE, WINDOWS XP, or other operating systems known in the art. Executing concurrently and cooperatively with operating system software 710 (FIG. 7B), IP Multicast capable TCP/IP software 712 manages the flow of information into and out of the control unit over the network interface 44. A JAVA enabled Internet browser 714, such as Netscape Navigator Microsoft Explorer or their equivalent in the art provide a web-browser user interface to networked resources through TCP/IP software 712.

Client control code 719 implements functions specific to the set top box or IRS operation, such as the processes depicted herein. Output is provided by user interface 918 in conjunction with Video Interface Code 720. Other clients 722 such as Email, facsimile, video conferencing applications or voice mail may also be supported. In a related embodiment, the functions of the set top unit are integrated into a television, forming an Internet capable, interactive “Smart Television.” In a related embodiment, the functions of the set top unit are integrated into a personal computer, forming an Internet: capable, interactive “Workstation Television.”

As used herein, whether in the above description or the following claims, the terms “comprising,” “including,” “carrying,” “having,” “containing,” “involving,” and the like are to be understood to be open-ended, that is, to mean including but not limited to. Only the transitional phrases “consisting of” and “consisting essentially of,” respectively, shall be considered exclusionary transitional phrases, as set forth, with respect to claims, in the United States Patent Office Manual of Patent Examining Procedures (Eighth Edition, August 2001 as revised October 2005), Section 2111.03.

Any use of ordinal terms such as “first,” “second,” “third,” etc., in the claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

The above described preferred embodiments are intended to illustrate the principles of the invention, but not to limit the scope of the invention. Various other embodiments and modifications to these preferred embodiments may be made by those skilled in the art without departing from the scope of the present invention.

1-20. (canceled)

21. A method, comprising the steps:
selecting a television program to record at a user device (106);
receiving a bit stream corresponding to the television program at a first bit rate at a server (104); and
receiving a bit stream corresponding to the television program at the user device (106) from the server (104) at a second bit rate less than the first bit rate, characterized by selecting a time period over which the recording may be made.

22. A method in accordance with claim 1, characterized in that said first bit rate corresponds to a real time bit rate.

23. A method in accordance with claim 1 or 2, characterized in that said second bit rate is a bit rate less than required for viewing the television program in real time.

24. A method in accordance with any of claims 1 to 3, further comprising adjusting an already-set time period.

25. A method in accordance with any of claims 1 to 4, further comprising setting a completion time for receiving said second bit rate bit stream.

26. A system, comprising:
a head-end encoder (102) configured to stream a television program to an intermediate server (104) operably coupled to the head end encoder at a first bit rate; and a user device (106) operably coupled to said intermediate server (104);
wherein the intermediate server (104) is configured to selectively stream the television program to the user device (106) at less than the first bit rate, characterized in that said user device (106) is configured to select a time period over which to receive the television program from said intermediate server (104).

27. A system in accordance with claim 6, characterized in that said first bit rate is real time and said second bit rate is less than real time and corresponds to the selected time period.

28. A system in accordance with claim 6 or 7, characterized in that said user device (106) comprises an Internet. Protocol Television (IPTY) set top box.

29. A system in accordance with any of claims 6 to 8, characterized in that the time period is a duration over which to receive the television program from the intermediate server (104).

30. A system in accordance with any of claims 6 to 9, characterized in that the time period includes a completion time by which the television program is received from the intermediate server (104).

31. A system in accordance with any of claims 6 to 10, characterized in that the time period is user-adjustable once set.

32. A program product stored on one or more computer readable devices, the program product comprising:
code executable to cause selecting a television program to record at a user device (106);
code executable to cause receiving a bit stream corresponding to the television program at a first bit rate at a server (104); and
code executable to cause receiving a bit stream corresponding to the television program at said user device (106) from said server (104) at a second bit rate less than the first bit rate, characterized by code executable to cause selecting a time period over which the recording may be made.

33. A program product in accordance with claim 12, characterized in that said first bit rate corresponds to a real time bit rate.

34. A program product in accordance with claim 12 or 13, characterized in that said second bit rate is a bit rate less than required for viewing the television program in real time.

35. A system, comprising:
a television source (102) configured to stream a television program at a first bit rate;
a server (104) configured to receive a first stream at said first bit rate corresponding to the television program from the television source (102); and
a plurality of set top boxes coupled to said server (104), at least one of the set top boxes configured to receive a second stream at a second bit rate from said server (104) over a specified time period, said second bit rate being less than said first bit rate.

36. A system in accordance with claim 15, wherein said first bit rate is a real time bit rate.

37. A system in accordance with claim 15 or 16, wherein said second bit rate is a bit rate less than needed to view the television program in real time.
